(19) United States
(12) Patent Application Publication
(10) Pub. No.: US 2025/0365537 A1
(43) Pub. Date: Nov. 27, 2025

(54) SIGNAL PROCESSING DEVICE, SIGNAL PROCESSING METHOD, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Moe TAKADA, Osaka (JP); Ryota MIYANAKA, Osaka (JP)

(21) Appl. No.: 19/286,570

(22) Filed: Jul. 31, 2025

Related U.S. Application Data
(63) Continuation of application No. PCT/JP2024/001058, filed on Jan. 17, 2024.

(30) Foreign Application Priority Data
Feb. 2, 2023 (JP) 2023-014776

(51) Int. Cl. H04R 3/04

(52) U.S. Cl. CPC H04R 3/04; H04R 2430/01

(57) ABSTRACT

A signal processing device includes an acquisition unit that acquires a sound source signal, a separation unit that separates the sound source signal having been acquired into a target sound signal and a background sound signal, a volume adjustment unit that emphasizes the target sound signal by adjusting a volume of the target sound signal having been separated, an adding unit that generates an output signal by adding the emphasized target sound signal that is the target sound signal having been emphasized and the sound source signal, and an output unit that causes a sound indicated by the output signal to be output from a speaker.

### FIELD OF INVENTION

The present disclosure relates to a technique of reproducing a sound source signal.

### BACKGROUND ART

Patent Literature 1 discloses a technique of performing spectrum emphasis according to a degree of deterioration of frequency selectivity of a hearing aid user. Specifically, Patent Literature 1 discloses separating an input sound signal into a first band sound signal and a second band sound signal on a lower band side than the first band sound signal, performing Fourier transformation on the separated first band sound signal to extract a fundamental wave component of vowel sound and a part of harmonics for the obtained signal, generating an attenuation waveform (emphasis waveform) according to a degree of deterioration of frequency selectivity of an individual on the basis of the extracted fundamental wave component and the harmonic component, convolving the generated attenuation waveform into the first band sound signal, and adding convoluted sound data to the second band sound signal.

Patent Literature 2 discloses a technique of effectively emphasizing a voice component and a background component included in a sound source signal. Specifically, Patent Literature 2 discloses separating an input sound source signal into a voice signal and a background sound signal, multiplying the voice signal by a first gain, multiplying the background sound signal by a second gain, and adding and outputting the voice signal multiplied by the first gain and the background sound signal multiplied by the second gain.

However, in the above conventional technique, since distortion generated in the process of emphasizing the target sound signal such as the voice signal is not suppressed and is directly output, it is difficult to hear the target sound in a noise environment.
Patent Literature 1: JP 2021-157134 A
Patent Literature 2: WO 2015/097892 A

### SUMMARY OF THE INVENTION

The present disclosure has been made in view of such a problem, and an object of the present disclosure is to provide a technique of making it easy to hear a target sound in a noise environment.

A signal processing device according to an aspect of the present disclosure includes an acquisition unit that acquires a sound source signal, a separation unit that separates the sound source signal having been acquired into a target sound signal and a background sound signal, a volume adjustment unit that emphasizes the target sound signal by adjusting a volume of the target sound signal having been separated, an adding unit that generates an output signal by adding an emphasized target sound signal that is the target sound signal having been emphasized and the sound source signal, and an output unit that causes a sound indicated by the output signal to be output from a speaker.

The present disclosure makes it easy to hear a target sound in a noise environment.

### BRIEF DESCRIPTION OF THE DRAWINGS

FIG. 1 is an installation diagram of an acoustic device according to an embodiment of the present disclosure.

FIG. 2 is a block diagram illustrating an example of a configuration of an acoustic device according to the embodiment of the present disclosure.

FIG. 3 is a block diagram illustrating an example of a configuration of a separation unit including Conv-Tasnet.

FIG. 4 is a flowchart illustrating an example of processing of a signal processing device according to the embodiment of the present disclosure.

FIG. 5 is a diagram illustrating a state of signal processing in a comparative example to which automatic gain control is not applied.

FIG. 6 is a diagram for describing an effect of the automatic gain control.

FIG. 7 is an explanatory diagram of compressor processing.

FIG. 8 is a diagram illustrating an outline of the processing of the signal processing device according to the present embodiment.

FIG. 9 is a waveform diagram of an output signal in a comparative example.

FIG. 10 is a waveform diagram of an output signal according to the present embodiment.

### DETAILED DESCRIPTION

### (Process Leading to Aspect of Present Disclosure)

In recent years, a technique has been studied in which an array speaker (headphone-less speaker) is installed in a booth provided for each of a plurality of seats in a cabin of an airplane or the like, and a sound of content such as a movie is reproduced from the array speaker so as not to leak the sound to the outside of the booth. The content such as a movie includes an uttered voice (for example, lines) uttered by a person and a background sound such as a sound effect or music. Since the surrounding noise is large in the cabin, the uttered voice is buried in the noise, and a viewer often cannot be able to accurately hear the uttered voice. In this case, the viewer cannot sufficiently understand the content of the content.

Therefore, if only the uttered voice among the sounds of the content is emphasized and output from the array speaker, the viewer can accurately hear the uttered voice. However, conventionally, in a case where distortion occurs in the process of emphasizing only the uttered voice, there is a problem that the distortion is not suppressed and is directly output. This problem makes it difficult for the viewer to hear the uttered voice in a noise environment.

In Patent Literature 1, an attenuation waveform (emphasis waveform) corresponding to a degree of deterioration in frequency selectivity of an individual is generated from a first band sound signal, the generated attenuation waveform is convolved into the first band sound signal, and the obtained sound data is added to a second band sound signal to generate an output signal. As described above, in Patent Literature 1, since the sound data obtained by the convolution is added to the second band sound signal, in a case where distortion occurs in the process of generating the attenuation waveform, there is a possibility that the distortion is directly output without being suppressed.

In Patent Literature 2, since the output signal is generated by adding the voice signal multiplied by the first gain and the background sound signal multiplied by the second gain, in a case where distortion occurs in the voice signal multiplied by the first gain, there is a possibility that the distortion is directly output without being suppressed.

It has been found that such a problem of the conventional technique occurs because the target sound signal (such as the voice signal) separated from the sound source signal is emphasized and then added not to the sound source signal but to the background sound signal separated from the sound source signal.

Therefore, the inventors have obtained knowledge that, if an emphasized target sound signal is added to a sound source signal in which distortion does not occur because the sound source signal is not subjected to any processing, distortion generated in the process of emphasizing the target sound signal is compensated by the sound source signal, and thus, the target sound can be easily heard in a noise environment, and have arrived at each aspect of the present disclosure.

(1) A signal processing device according to an aspect of the present disclosure includes an acquisition unit that acquires a sound source signal, a separation unit that separates the sound source signal having been acquired into a target sound signal and a background sound signal, a volume adjustment unit that emphasizes the target sound signal by adjusting a volume of the target sound signal having been separated, an adding unit that generates an output signal by adding an emphasized target sound signal that is the target sound signal having been emphasized and the sound source signal, and an output unit that causes a sound indicated by the output signal to be output from a speaker.

In this configuration, since the emphasized target sound signal, which is the emphasized target sound signal, is added to the sound source signal to generate the output signal. Therefore, even if distortion occurs in the process of generating the emphasized target sound signal, the distortion is compensated by the sound source signal, and the distortion is suppressed. It is therefore possible to make it easy to hear a target sound in a noise environment.

(2) In the signal processing device according to (1), the separation unit may include a learning model generated in advance to separate the sound source signal into the target sound signal and the background sound signal, and learning data used for learning the learning model may be generated by combining the target sound signal and at least one type of the background sound signal.

In this configuration, since the learning data is generated by combining the target sound signal and the at least one type of the background sound signal, the learning data corresponding to various cases can be easily generated. Then, since the learning model is learned by using such learning data, the target sound signal and the background sound signal can be accurately separated from various sound source signals.

(3) In the signal processing device according to (1) or (2), each of the emphasized target sound signal and the sound source signal may be a time signal, and the adding unit may add the emphasized target sound signal and the sound source signal in a time domain.

In this configuration, since each of the emphasized target sound signal and the sound source signal is a time signal, and the emphasized target sound signal and the sound source signal are added in the time domain, the occurrence of distortion can be further suppressed.

(4) In the signal processing device according to any one of (1) to (3), the volume adjustment unit may generate the emphasized target sound signal by automatic gain control, and the automatic gain control may amplify the target sound signal when the volume of the target sound signal does not exceed a reference volume, and may attenuate the target sound signal to set a volume of the target sound signal to be smaller than the reference volume when the volume of the target sound signal exceeds the reference volume.

In this configuration, since the target sound signal that does not exceed the reference volume is amplified and the target sound signal that exceeds the reference volume is attenuated so as not to exceed the reference volume, it is possible to prevent the target sound signal from exceeding the reference volume while a small sound included in the target sound signal is emphasized.

(5) In the signal processing device according to any one of (1) to (4), the output unit may execute compressor processing of compressing the output signal so that a volume of the output signal does not exceed a maximum volume.

In this configuration, since the output signal is compressed so that the volume of the output signal does not exceed the maximum volume, it is possible to prevent clipping of the output signal.

(6) In the signal processing device according to any one of (1) to (5), the speaker may include an array speaker.

In this configuration, the output signal can be heard only in a predetermined area.

(7) In the signal processing device according to any one of (1) to (6), the target sound signal may be a speech signal indicating a voice uttered by a person.

Therefore, it is possible to avoid difficulty in hearing the speech signal in a noise environment.

(8) In the signal processing device according to any one of (1) to (6), the sound source signal may be an in-vehicle sound signal indicating an in-vehicle sound of a traveling mobile body, and the target sound signal may be a signal indicating a warning sound or a sound output from a car navigation system.

In this configuration, it is possible to avoid difficulty in hearing the warning sound or the sound output from the car navigation system while hearing the surrounding environmental sound in the mobile body.

(9) In the signal processing device according to any one of (1) to (6), the sound source signal may be an acoustic signal indicating sounds of a plurality of musical instruments, and the target sound signal may be a signal indicating a sound of a specific musical instrument among the plurality of musical instruments.

In this configuration, it is possible to clearly hear the sound of the specific musical instrument from the acoustic signal.

(10) In the signal processing device according to any one of (1) to (6), the sound source signal may be a content sound signal indicating a content sound included in a video content, and the target sound signal may be a signal indicating a specific sound effect of the content sound.

In this configuration, it is possible to clearly hear the specific sound effect of the content sound.

(11) In the signal processing device according to any one of (1) to (10), the signal processing device may be installed in a booth provided inside a vehicle.

In this configuration, since the target sound is easily heard, it is possible to avoid difficulty in hearing the target sound signal due to noise in the vehicle.

(12) In the signal processing device according to (4), the signal processing device may be installed in a booth provided inside a vehicle, and the reference volume may be a volume of the emphasized target sound signal in which the sound output from the speaker is assumed to leak to outside of the booth.

In this configuration, since the volume of the target sound signal is reduced to be lower than the reference volume by the automatic gain control, the sound output from the speaker can be prevented from leaking to the outside of the booth.

(13) In the signal processing device according to (4) or (12), in the automatic gain control, when the volume of the target sound signal does not exceed the reference volume, the target sound signal may be amplified with a predetermined gain, and the predetermined gain may have a value that allows a volume of a whisper included in the target sound signal to be larger than a volume of a noise heard by a user.

In this configuration, since the automatic gain control makes the volume of a whisper larger than the volume of noise around the speaker, the user can hear the whispering sound.

(14) A signal processing method according to another aspect of the present disclosure is a signal processing method of a signal processing device, the method for executing processing of acquiring a sound source signal, separating the sound source signal having been acquired into a target sound signal and a background sound signal, emphasizing the target sound signal by adjusting a volume of the target sound signal having been separated, generating an output signal by adding an emphasized target sound signal that is the target sound signal having been emphasized and the sound source signal, and causing a sound indicated by the output signal to be output from a speaker.

This configuration can provide a signal processing method capable of avoiding difficulty in hearing the target sound signal in a noise environment.

(15) A signal processing program according to another aspect of the present disclosure causes a processor to execute processing of acquiring a sound source signal, separating the sound source signal having been acquired into a target sound signal and a background sound signal, emphasizing the target sound signal by adjusting a volume of the target sound signal having been separated, generating an output signal by adding an emphasized target sound signal that is the target sound signal having been emphasized and the sound source signal, and causing a sound indicated by the output signal to be output from a speaker.

This configuration can provide a signal processing program capable of avoiding difficulty in hearing the target sound signal in a noise environment.

The present disclosure can also be implemented as a signal processing system that is operated by such a signal processing program. It is needless to say that such a computer program can be distributed via a computer-readable non-transitory recording medium such as a CD-ROM or via a communication network such as the Internet.

Each of embodiments described below illustrates a specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, respective contents can be combined.

### EMBODIMENTS

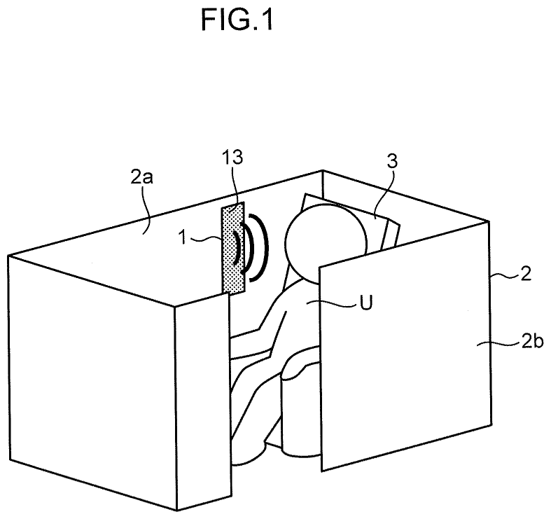

FIG. 1 is an installation diagram of an acoustic device 1 according to an embodiment of the present disclosure. The acoustic device 1 is installed inside a booth 2. The booth 2 is a partition provided for each seat 3 in an airplane, for example. The booth 2 is installed so as to surround the seat 3. The acoustic device 1 includes a speaker 13. The booth 2 includes a side wall 2a provided on one side of the seat 3 and a side wall 2b provided on the other side of the seat 3. The speaker 13 is provided, for example, on the side wall 2a. Note that the speaker 13 may be a pair of speakers. In this case, the pair of speakers 13 is installed, for example, on the side wall 2a and the side wall 2b. The installation position of the speaker 13 is not limited.

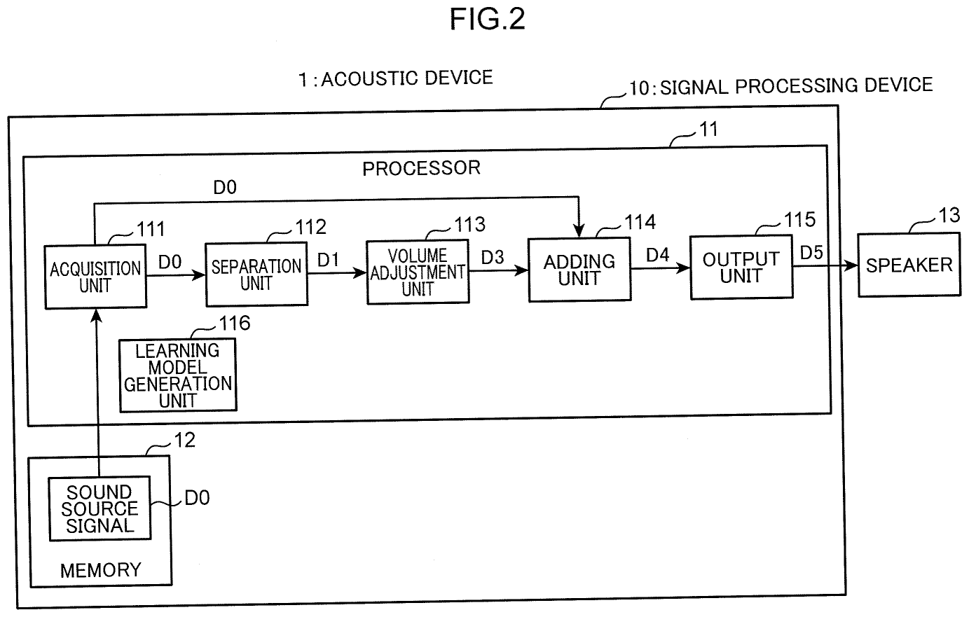

The speaker 13 includes, for example, an array speaker. As a result, a reproduction area of a sound output from the speaker 13 is set inside the booth 2, and a non-reproduction area of the sound is set outside the booth 2. As a result, sound leakage of the sound output from the speaker 13 to the outside of the booth 2 is prevented. There is severe noise such as engine sound and wind noise in the airplane, which makes it difficult for a user U to hear the sound output from the speaker 13. Contents such as a movie are often reproduced by the acoustic device 1 in the airplane. In this case, noise in the airplane makes it difficult for the user U to hear an uttered voice such as lines among sounds of the content. On the other hand, increasing the volume of the sound output from speaker 13 as a whole can cause sound leakage. Therefore, the acoustic device 1 includes a signal processing device 10 (FIG. 2) that emphasizes the uttered voice so as to make the uttered voice to be heard easily. Hereinafter, a signal of a sound to be emphasized such as an uttered voice is referred to as a target sound signal.

FIG. 2 is a block diagram illustrating an example of a configuration of the acoustic device 1 according to the embodiment of the present disclosure. The acoustic device 1 includes the signal processing device 10 and the speaker 13. The signal processing device 10 includes a processor 11 and a memory 12. Examples of the processor 11 include a CPU and a signal processing circuit. The processor 11 includes an acquisition unit 111, a separation unit 112, a volume adjustment unit 113, an adding unit 114, an output unit 115, and a learning model generation unit 116. The acquisition unit 111 to the learning model generation unit 116 may be implemented by execution of the signal processing program by the processor 11, or may be configured by a dedicated hardware circuit. All or some of the constituent elements of the signal processing device 10 may be provided in a cloud server. The memory 12 includes, for example, a nonvolatile rewritable storage device such as a flash memory. The memory 12 stores a sound source signal D0. The sound source signal D0 is a sound signal included in content such as a movie. The learning model generation unit 116 may be provided in a learning device different from the acoustic device 1.

The acquisition unit 111 acquires the sound source signal D0 from the memory 12.

The separation unit 112 includes a learning model generated in advance to separate the sound source signal D0 acquired by the acquisition unit 111 into a target sound signal D1 and a background sound signal D2 (not illustrated). A target sound indicated by the target sound signal D1 is, for example, an uttered voice (for example, lines) of a person among sounds included in the content. A background sound indicated by the background sound signal D2 is a sound other than the uttered voice among the sounds included in the content, and is, for example, a traffic noise, a music piece not including a vocal, a sound effect, or the like.

As the learning model, for example, a model configured by a deep neural network can be adopted. Learning data used for learning the learning model is generated by combining the target sound signal and at least one type of the background sound signal. For example, examples of the target sound signal D1 include an uttered voice of a person, an uttered voice obtained by translating the uttered voice of a first language into a second language, a whisper in which a person speaks in a small voice, and an emotional voice that a person utters when expressing an emotion. For example, the first language is a native language of the speaker, and the second language is a language other than the native language. When the first language is Japanese, for example, examples of the second language include English, French, German, and Chinese.

The type of the background sound signal D2 is determined so as to be compatible with various scenes of a movie. Examples of types of the background sound signal D2 include traffic noise, music including no vocal, and sound effects. Note that the learning data may include a plurality of types of background sound signals. For example, examples of the combination of the learning data include one type of target sound signal (for example, Japanese speech signal) and two types of background sound signals (for example, traffic noise and music).

The learning model generation unit 116 acquires various types of target sound signals D1 and background sound signals D2 used for learning from, for example, the memory 12 or an external server. Then, the learning model generation unit 116 generates a learning sound source signal in which the target sound signal D1 and the background sound signal D2 are superimposed by randomly combining one type of target sound signal and one or more types of background sound signals D2 from among the plurality of types of target sound signals D1 and the plurality of types of background sound signals D2 acquired. Then, the learning model generation unit 116 generates the learning model by causing the learning model to learn the learning sound source signal.

Specifically, the learning model generation unit 116 adjusts parameters of the learning model so as to minimize an error between the target sound signal D1 output from the learning model when the learning sound source signal is input to the learning model and the target sound signal D1 constituting the input learning sound source signal and an error between the background sound signal D2 output from the learning model when the learning sound source signal is input to the learning model and the background sound signal D2 constituting the input learning sound source signal.

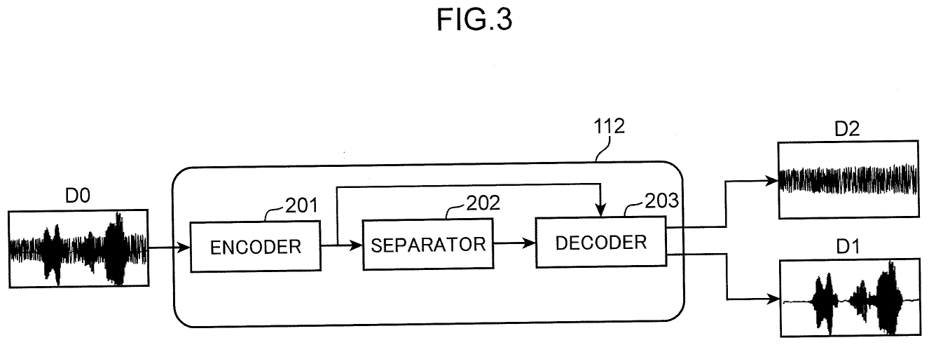

Example of the learning model include Conv-Tasnet. FIG. 3 is a block diagram illustrating an example of a configuration of the separation unit 112 including Conv-Tasnet. The separation unit 112 includes an encoder 201, a separator 202, and a decoder 203.

The encoder 201 detects a feature amount of the sound source signal D0. The separator 202 estimates a target sound mask and a background sound mask from the feature amount detected by the encoder 201. The target sound mask is a separation mask for extracting a feature amount of the target sound signal D1 from the feature amount of the sound source signal D0. The background sound mask is a separation mask for extracting a feature amount of the background sound signal D2 from the feature amount of the sound source signal D0. The decoder 203 multiplies the feature amount detected by the encoder 201 by the target sound mask to calculate the feature amount of the target sound signal D1, and converts the feature amount of the target sound signal D1 into a sound signal to generate the target sound signal D1. Furthermore, the decoder 203 calculates the feature amount of the background sound signal D2 by multiplying the feature amount detected by the encoder 201 by the background sound mask, and converts the feature amount of the background sound signal D2 into the sound signal to generate the background sound signal D2 by. As a result, the sound source signal D0 is separated into the target sound signal D1 and the background sound signal D2.

In a case where Conv-Tasnet is adopted as the learning model, a target sound mask, a background sound mask, a parameter for estimating the target sound mask, a parameter for estimating the background sound mask, a parameter for detecting a feature amount, and the like are learned through learning based on learning data.

In the present embodiment, the separation unit 112 is configured by Conv-Tasnet, but this is merely an example, and Tasnet may be adopted. In any case, any learning model may be adopted as long as the target sound signal D1 and the background sound signal D2 can be separated from the sound source signal D0. Alternatively, the separation unit 112 may separate the target sound signal D1 and the background sound signal D2 from the sound source signal D0 by a method other than machine learning. For example, the separation unit 112 may separate the target sound signal D1 and the background sound signal D2 from the sound source signal D0 by performing Fourier transform on the sound source signal D0 and applying a time frequency mask to the sound source signal in an obtained frequency band.

See FIG. 2 again. The volume adjustment unit 113 emphasizes the target sound signal D1 by adjusting the volume of the target sound signal D1 separated by the separation unit 112. For example, the volume adjustment unit 113 adjusts the volume of the target sound signal D1 to an optimum volume by applying the automatic gain control to the target sound signal D1. Here, examples of the automatic gain control include processing of amplifying the target sound signal D1 with a first gain G1 (an example of a predetermined gain) in a case where the volume of the target sound signal D1 does not exceed a predetermined reference volume, and attenuating the target sound signal with a second gain that reduces the volume of the target sound signal D1 to be lower than the reference volume in a case where the volume of the target sound signal D1 exceeds the reference volume.

As the first gain G1, for example, a value capable of making the volume of a whispering sound of a person larger than a surrounding volume assumed to be heard by the user in the booth 2 is adopted.

For example, the second gain G2 may be set such that a degree of attenuation increases as an excess amount of the sound volume of the target sound signal D1 exceeding the reference volume increases. Hereinafter, the target sound signal D1 whose volume has been adjusted by the volume adjustment unit 113 is referred to as an emphasized target sound signal D3.

The reference volume refers to a volume of the emphasized target sound signal D3 at which sound output from the speaker 13 is assumed to leak to the outside of the booth 2.

The adding unit 114 generates an addition signal D4 by adding the sound source signal D0 input from the acquisition unit 111 and the emphasized target sound signal D3 input from the volume adjustment unit 113. As a result, even if distortion occurs in the process of generating the emphasized target sound signal D3, the distortion is compensated by the sound source signal D0, and the addition signal D4 in which distortion is suppressed is obtained. Here, both the sound source signal D0 and the emphasized target sound signal D3 are time signals. Therefore, the adding unit 114 adds the sound source signal D0 and the emphasized target sound signal D3 in a time domain.

The output unit 115 generates an output signal D5 from the addition signal D4 and causes the speaker 13 to output a sound indicated by the output signal D5. As a result, the sound of the content is output from the speaker 13. Here, the output unit 115 may execute compressor processing of compressing the addition signal D4 so that the volume of the addition signal D4 does not exceed a predetermined maximum volume. The maximum volume is a volume at which clipping occurs when the volume is further increased. However, this is merely an example, and the output unit 115 may directly use the addition signal D4 as the output signal D5. Here, the output unit 115 may generate the output signal D5 so as to realize area reproduction in which the inside of the booth 2 is a reproduction area and the outside of the booth 2 is a non-reproduction area. For example, the output unit 115 is only required to realize the area reproduction by adjusting, for example, a phase of the output signal input to each of a plurality of speaker elements constituting the speaker 13. Note that, a method of the area reproduction is known, and will be omitted from description here.

The speaker 13 includes an array speaker in which a plurality of speaker elements is arranged in a line. As a result, the area reproduction is realized.

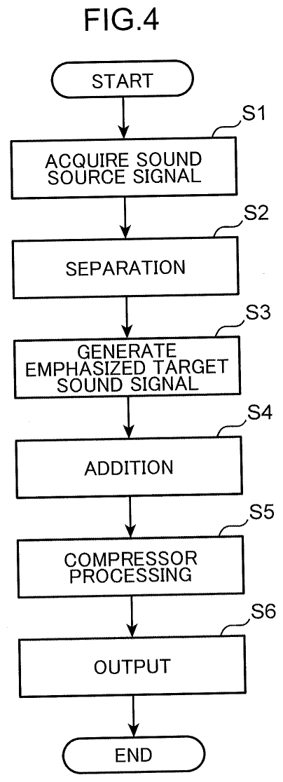

FIG. 4 is a flowchart illustrating an example of processing of the signal processing device 10 according to the embodiment of the present disclosure.

First, the acquisition unit 111 acquires the sound source signal D0 from the memory 12 (step S1). Next, the separation unit 112 separates the sound source signal D0 acquired in step S1 into the target sound signal D1 and the background sound signal D2 (step S2). Next, the volume adjustment unit 113 applies the automatic gain control to the target sound signal D1 separated in step S2 to generate the emphasized target sound signal D3 (step S3).

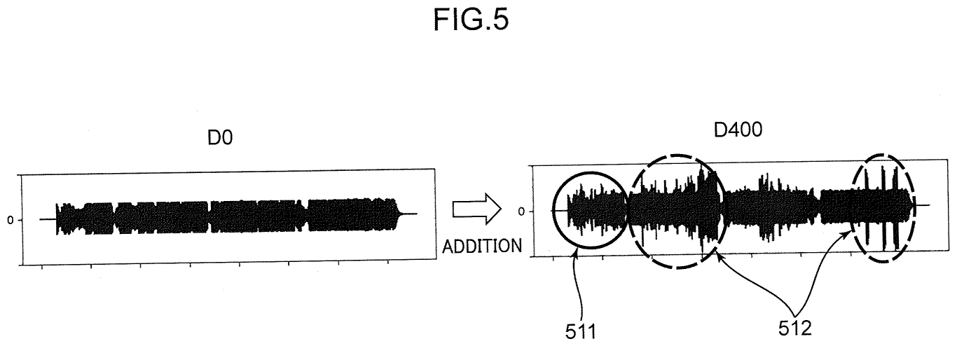

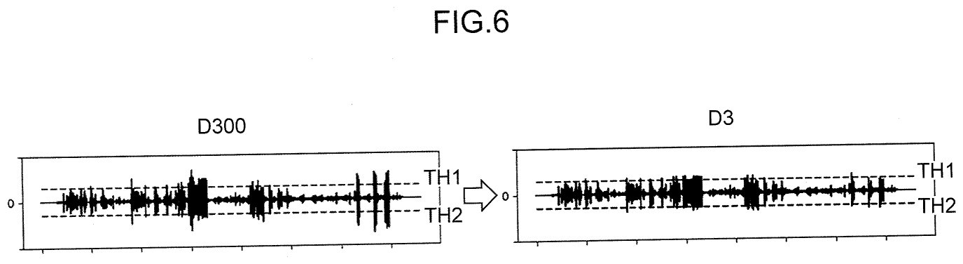

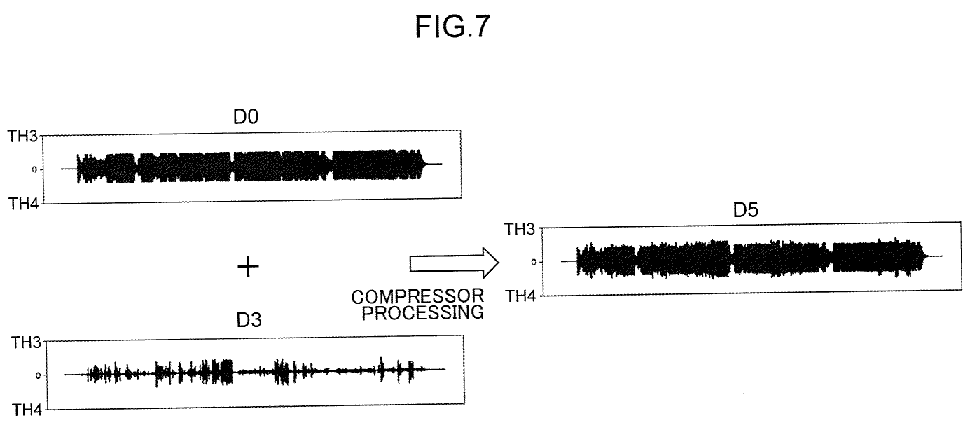

FIG. 5 is a diagram illustrating a state of signal processing in a comparative example to which the automatic gain control is not applied. The left diagram in FIG. 5 illustrates the sound source signal D0, and the right diagram in FIG. 5 illustrates an addition signal D400 to which the automatic gain control is not applied. In both the left diagram and the right diagram in FIG. 5, the vertical axis represents sound volume, and the horizontal axis represents time. The same applies to FIGS. 6 and 7 described later.

The addition signal D400 is generated by adding the sound source signal D0 to the target sound signal D1 uniformly amplified by the first gain G1 regardless of whether the volume exceeds the reference volume. In the addition signal D400, a region 511 indicates a whisper, and a region 512 indicates a normal uttered voice. In the comparative example, since the target sound signal D1 is amplified by the first gain G1, the user U can hear a whispering sound. However, in the comparative example, since the normal uttered voice is also amplified with the first gain G1, the normal uttered voice is excessively amplified as indicated by the region 512. Therefore, in the comparative example, there is a possibility that the sound output from the speaker 13 leaks to the outside of the booth 2. Therefore, in the present embodiment, the automatic gain control is applied to the target sound signal D1 to generate the emphasized target sound signal D3.

FIG. 6 is a diagram for describing an effect of the automatic gain control. The left diagram in FIG. 6 illustrates an emphasized target sound signal D300 in the comparative example, and the right diagram in FIG. 6 illustrates the emphasized target sound signal D3 in the present embodiment. An upper limit reference volume TH1 has a positive value of the reference volume, and a lower limit reference volume TH2 has a negative value of the reference volume.

The emphasized target sound signal D300 is generated by amplifying the target sound signal D1 with the first gain G1. In the emphasized target sound signal D300, some peaks of the plurality of peaks exceed the upper limit reference volume TH1 and some other peaks falls below the lower limit reference volume TH2. Therefore, in the comparative example, there is a possibility that the sound output from the speaker 13 leaks to the outside of the booth 2.

Therefore, in the present embodiment, the volume adjustment unit 113 applies the automatic gain control to the target sound signal D1. Specifically, the volume adjustment unit 113 attenuates the target sound signal D1 with the second gain G2 when the volume of the target sound signal D1 exceeds the upper limit reference volume TH1 or when the volume of the target sound signal D1 falls below the lower limit reference volume TH2. On the other hand, when the volume of the target sound signal D1 is within a range of the upper limit reference volume TH1 and the lower limit reference volume TH2, the volume adjustment unit 113 amplifies the target sound signal D1 with the first gain G1. As a result, in the emphasized target sound signal D3, the volume falls within the range of the upper limit reference volume TH1 and the lower limit reference volume TH2.

See FIG. 4 again. In step S4, the adding unit 114 generates an addition signal D4 by adding the emphasized target sound signal D3 generated in step S3 to the sound source signal D0 acquired in step S1.

Next, the output unit 115 generates the output signal D5 by applying the compressor processing to the addition signal D4 (step S5). FIG. 7 is an explanatory diagram of the compressor processing. The addition signal D4 is generated by adding the emphasized target sound signal D3 to the sound source signal D0, and the output signal D5 is generated from the addition signal D4. However, when the volumes of the sound source signal D0 and the emphasized target sound signal D3 are intensified, the volume of the output signal D5 exceeds an upper limit maximum volume TH3 or the volume of the output signal D5 falls below a lower limit maximum volume TH4. The upper limit maximum volume TH3 has a positive value of the maximum volume, and the lower limit maximum volume TH4 has a negative value of the maximum volume. When the output signal D5 exceeds the upper limit maximum volume TH3, the output signal D5 is clipped. When the output signal D5 falls below the lower limit maximum volume TH4, the output signal D5 is clipped. Therefore, the output unit 115 applies the compressor processing to the addition signal D4 generated by the adding unit 114 to generate the output signal D5. The compressor processing is processing of compressing the addition signal D4 so that the volume of the output signal D5 falls within a range of the upper limit maximum volume TH3 and the lower limit maximum volume TH4. It is therefore possible to suppress clipping of the output signal D5.

See FIG. 4 again. In step S6, the output unit 115 outputs the sound of the content from the speaker 13 by inputting the output signal D5 to the speaker 13.

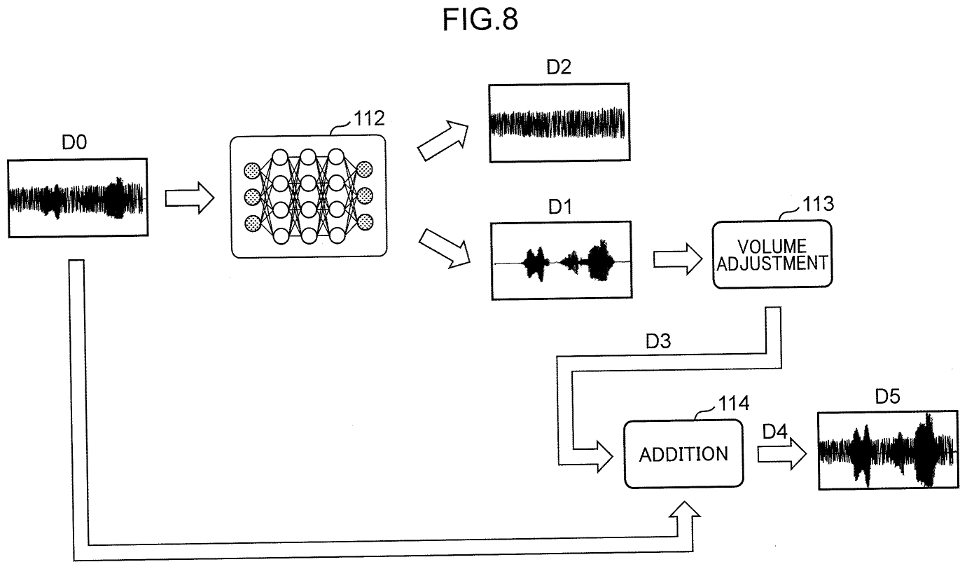

FIG. 8 is a diagram illustrating an outline of the processing of the signal processing device 10 according to the present embodiment. The sound source signal D0 is separated by the separation unit 112 into the target sound signal D1 and the background sound signal D2. The volume of the separated target sound signal D1 is adjusted by the automatic gain control by the volume adjustment unit 113, and the emphasized target sound signal D3 is generated. The emphasized target sound signal D3 is added to the sound source signal D0 by the adding unit 114 to generate the addition signal D4. The addition signal D4 is subjected to the compressor processing by the output unit 115, the output signal D5 is generated, and the output signal D5 is input to the speaker 13. As a result, the sound of the content is output from the speaker 13.

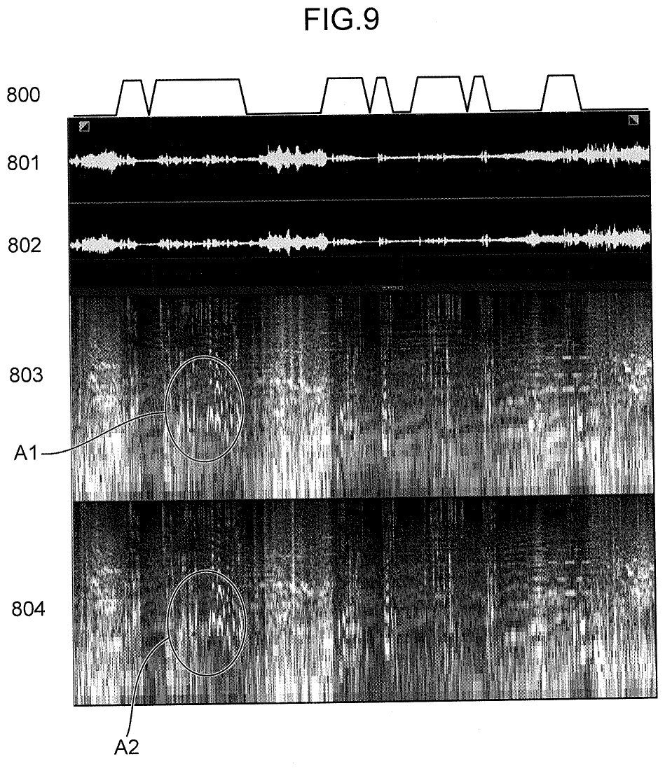

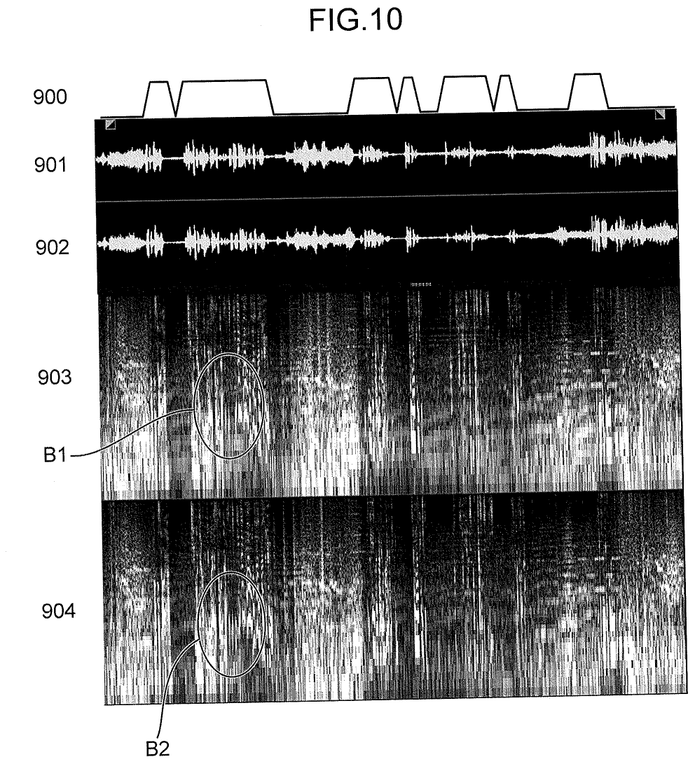

FIG. 9 is a waveform diagram of an output signal in a comparative example. FIG. 10 is a waveform diagram of an output signal according to the present embodiment. In the comparative example illustrated in FIG. 9, the volume of the speech signal that is the target sound signal D1 is not adjusted. FIGS. 9 and 10 illustrate output signals 801 and 802 configured by two-channel stereo sound. A spectrogram 803 is a spectrogram of the output signal 801 and a spectrogram 804 is a spectrogram of the output signal 802. A high-level section in a waveform 800 is a speech section. In the spectrograms 803 and 804, the vertical axis represents frequency, and the horizontal axis represents time. The spectrograms 803 and 804 indicate that the higher the luminance, the larger the volume. The same applies to a waveform 900, output signals 901 and 902, and spectrograms 903 and 904 illustrated in FIG. 10.

For example, regions B1 and B2 illustrated in FIG. 10 are regions corresponding to regions A1 and A2 illustrated in FIG. 9, and are speech sections. The regions B1 and B2 have a larger volume as a whole than the regions A1 and A2 illustrated in FIG. 9. As a result, it can be seen that the volume of the speech signal is emphasized in the present embodiment.

As described above, in the present embodiment, since the emphasized target sound signal D3, which is the emphasized target sound signal D1, is added to the sound source signal D0 to generate the output signal D5. Therefore, even if distortion occurs in the process of generating the emphasized target sound signal D3, the distortion is compensated by the sound source signal D0, and the distortion is suppressed. It is therefore possible to avoid difficulty in hearing the target sound in a noise environment.

Modifications described below can be adopted for the present disclosure.

(1) The volume adjustment unit 113 may emphasize only a specific band instead of emphasizing an entire band of the target sound signal D1. For example, the volume adjustment unit 113 may apply filtering processing using a filter for increasing the volume of only a specific band to the target sound signal D1. The specific band is, for example, a female voice band, a male voice band, or the like. For example, in a case where the acquisition unit 111 acquires information indicating that it is difficult to listen to a specific band from the user U, the volume adjustment unit 113 applies a filter for increasing only the volume of the specific band to the target sound signal D1 to generate the emphasized target sound signal D3 in which only the specific band is emphasized.

(2) In the above embodiment, the target sound signal D1 is a speech signal, but this is merely an example, and the target sound signal D1 may be a signal other than the speech signal. For example, the target sound signal D1 may be a signal indicating a specific sound (for example, sound effect, background sound, or music) included in the content. In this case, the separation unit 112 may separate the target sound signal D1 and the remaining sound signal from the sound source signal D0 by using a learning model learned to separate the sound source signal D0 into a specific sound and the remaining sound.

(3) In the above embodiment, the acoustic device 1 is installed in an airplane, but may be installed in a train, a bus, or the like. The acoustic device 1 may be installed in a booth provided in a crowded place, or may be installed in a booth provided in an office.

(4) The sound source signal may be an in-vehicle sound signal indicating an in-vehicle sound of a traveling mobile body. In this case, the target sound signal may be a warning sound or a signal indicating a sound output from a car navigation system. As the warning sound, for example, a warning sound output by an emergency vehicle such as an ambulance, a fire engine, and a patrol car can be adopted. The mobile body is, for example, a four-wheeled automobile. As the sound output from the car navigation system, for example, a guidance voice and a caution sound for route guidance can be adopted.

(5) The sound source signal may be, for example, an acoustic signal indicating a musical sound including sounds of a plurality of musical instruments, such as an orchestra or popular music. In this case, the target sound signal may be a signal indicating the sound of a specific musical instrument among the plurality of musical instruments. As the specific musical instrument, a guitar, a violin, a bass, a drum, a keyboard, a piano, a woodwind musical instrument, a brass musical instrument, or the like can be employed.

(6) The sound source signal may be a content sound signal indicating a content sound included in a video content. As the video content, for example, a movie, a landscape video, or the like can be adopted. In this case, as the sound source signal, a sound signal used in a movie or a sound in the natural world collected when a scene is captured can be adopted. In this case, a signal indicating a specific sound effect can be adopted as the target sound signal. As the specific sound effect, for example, in a case where the video content is a movie, a sound effect used in the movie can be adopted. For example, in a case where the video content is a landscape video, birdsong, a river sound, a sea sound, or the like can be adopted as the specific sound effect.

### INDUSTRIAL APPLICABILITY

The present disclosure makes it easy for a target sound to be heard in a noise environment, and is useful for an acoustic device installed in a cabin such as an airplane.

1. A signal processing device comprising:
an acquisition unit that acquires a sound source signal;
a separation unit that separates the sound source signal having been acquired into a target sound signal and a background sound signal;
a volume adjustment unit that emphasizes the target sound signal by adjusting a volume of the target sound signal having been separated;
an adding unit that generates an output signal by adding an emphasized target sound signal that is the target sound signal having been emphasized and the sound source signal; and
an output unit that causes a sound indicated by the output signal to be output from a speaker.

2. The signal processing device according to claim 1, wherein
the separation unit includes a learning model generated in advance to separate the sound source signal into the target sound signal and the background sound signal, and
learning data used for learning the learning model is generated by combining the target sound signal and at least one type of the background sound signal.

3. The signal processing device according to claim 1, wherein
each of the emphasized target sound signal and the sound source signal is a time signal, and
the adding unit adds the emphasized target sound signal and the sound source signal in a time domain.

4. The signal processing device according to claim 1, wherein
the volume adjustment unit generates the emphasized target sound signal by automatic gain control, and
the automatic gain control amplifies the target sound signal when the volume of the target sound signal does not exceed a reference volume, and attenuates the target sound signal to set a volume of the target sound signal to be smaller than the reference volume when the volume of the target sound signal exceeds the reference volume.

5. The signal processing device according to claim 1, wherein the output unit executes compressor processing of compressing the output signal so that a volume of the output signal does not exceed a maximum volume.

6. The signal processing device according to claim 1, wherein the speaker includes an array speaker.

7. The signal processing device according to claim 1, wherein the target sound signal is a speech signal indicating a voice uttered by a person.

8. The signal processing device according to claim 1, wherein
the sound source signal is an in-vehicle sound signal indicating an in-vehicle sound of a traveling mobile body, and
the target sound signal is a signal indicating a warning sound or a sound output from a car navigation system.

9. The signal processing device according to claim 1, wherein
the sound source signal is an acoustic signal indicating sounds of a plurality of musical instruments, and
the target sound signal is a signal indicating a sound of a specific musical instrument among the plurality of musical instruments.

10. The signal processing device according to claim 1, wherein
the sound source signal is a content sound signal indicating a content sound included in a video content, and
the target sound signal is a signal indicating a specific sound effect of the content sound.

11. The signal processing device according to claim 1, wherein the signal processing device is installed in a booth provided inside a vehicle.

12. The signal processing device according to claim 4, wherein
the signal processing device is installed in a booth provided inside a vehicle, and
the reference volume is a volume of the emphasized target sound signal in which the sound output from the speaker is assumed to leak to outside of the booth.

13. The signal processing device according to claim 4, wherein
in the automatic gain control, when the volume of the target sound signal does not exceed the reference volume, the target sound signal is amplified with a predetermined gain, and
the predetermined gain has a value that allows a volume of a whisper included in the target sound signal to be larger than a volume of a noise heard by a user.

14. A signal processing method of a signal processing device, the method comprising:
acquiring a sound source signal;
separating the sound source signal having been acquired into a target sound signal and a background sound signal;
emphasizing the target sound signal by adjusting a volume of the target sound signal having been separated;
generating an output signal by adding an emphasized target sound signal that is the target sound signal having been emphasized and the sound source signal; and
causing a sound indicated by the output signal to be output from a speaker.

15. A non-transitory computer readable recording medium storing a signal processing program that causes a processor to execute processing of:
acquiring a sound source signal;
separating the sound source signal having been acquired into a target sound signal and a background sound signal;
emphasizing the target sound signal by adjusting a volume of the target sound signal having been separated;
generating an output signal by adding an emphasized target sound signal that is the target sound signal having been emphasized and the sound source signal; and
causing a sound indicated by the output signal to be output from a speaker.
